(19) United States
(12) Patent Application Publication
(10) Pub. No.: US 2025/0355128 A1
(43) Pub. Date: Nov. 20, 2025

(54) UPHOLE VELOCITY MODELING BY STATISTICS AND MACHINE LEARNING

(71) Applicant: Saudi Arabian Oil Company, Dhahran (SA)

(72) Inventors: Daniele Colombo, Dhahran (SA); Hala Alqatari, Dhahran (SA); Ersan Turkoglu, Dhahran (SA); Diego Rovetta, Delft (NL)

(21) Appl. No.: 18/663,311

(22) Filed: May 14, 2024

(51) Int. Cl. G01V 1/30; G01V 1/28; G01V 1/34; G06N 3/0499; G06N 3/09

(52) U.S. Cl. CPC G01V 1/303; G01V 1/282; G01V 1/345; G06N 3/0499; G06N 3/09

(57) ABSTRACT

Constructing a velocity model from uphole seismic survey data using a statistical approach or a machine learning (ML) model. The uphole travel time vs. depth data from the uphole seismic survey is processed by fitting a smoothing function and removing outliers to form an uphole travel time vs. depth function that is then discretized to depth intervals. In the statistical approach, the discretized uphole travel time vs. depth function is segmented by piecewise linear functions, and the linear segments are used to interpret the interval velocities at the corresponding depth intervals. In the machine learning approach, a machine learning model is trained using synthetic uphole travel time data. The trained machine learning model is provided to determine interval velocities from the uphole travel time vs. depth data from the uphole seismic survey.

### BACKGROUND

### Field of the Disclosure

The present disclosure generally relates to geophysical exploration using seismic surveying. More specifically, embodiments of the disclosure relate to constructing a velocity model from uphole surveys.

### Description of the Related Art

In geophysical exploration, such as the exploration for hydrocarbons, seismic surveys are performed to produce images of the various rock formations in the earth (“subsurface”) or underwater (“subsea”). The seismic surveys obtain seismic data indicating the response of the rock formations to the travel of elastic wave seismic energy. The resulting seismic data is processed and analyzed to yield information relating to produce seismic images of the formations and their locations in an area of interest beneath the earth's surface. However, various features and layers of the earth may make accurate imaging and interpretation of subsurface reservoirs difficult.

### SUMMARY

Oil and gas exploration on land suffers from the complex physical parameter distributions occurring in the undersaturated shallow layer of the near surface (referred to as the “weathering” layer). In arid regions the weathering is typically deep, such as up to hundreds of meters. This undersaturated layer may be problematic as the low velocities associated with it are difficult to infer with conventional seismic acquisition layouts tuned to target deep reservoirs. Another recurrent problem in the near surface analysis is related to shallow velocity inversions with tabular geology (that is, the sequence of high velocity sub-horizontal layers overlying lower velocity layers). Such conditions cannot be resolved by using refraction seismology, as the velocity inversions do not produce refractions. As a result, the low velocity layers are hidden (that is, a so called “hidden layer”) or may give rise to “shingling,” which refers to the presence of vanishing amplitudes versus offset of the refracted arrivals followed by secondary and later arrivals. In such cases, the drilling of shallow boreholes and the interpretation of the P-wave travel times associated with the vertical travel paths may provide the interval velocities versus depth that are used to calibrate the velocity field, especially for the weathering layer and for the low velocity hidden layers. A robust interpretation of the uphole travel times in terms of interval velocity versus depth may help avoid near surface-related distortions of deep seismic images. The poor reflectivity imaging or the distorted geometrical imaging of deep structures associated to prospects augments the risk of drilling dry wells or of missing true exploration targets.

Because of these problems, specific investigations may be performed for the shallow near surface by means of what is known as “uphole surveys.” In an uphole survey, a source is lowered within a shallow borehole (for example, 100-500 meters depth) and the uphole times are recorded by seismic receivers (for example, geophones) located on the surface in proximity of the borehole. The uphole (that is, vertical) travel times are interpreted for the interval velocities and a detailed velocity profile is obtained for describing the velocity structure of the weathering layer and of the investigated near surface below the weathering layer.

By way of example, FIGS. 1A and 1B depict a schematic of an uphole survey in accordance with an embodiment of the disclosure. FIG. 1A depicts a schematic of borehole lithology with different layers depicted vs depth of the borehole 100. FIG. 1B depicts an arrangement of an uphole survey with seismic source array 102 and a receiver 104. FIGS. 1C and 1D depicts results from an uphole survey in accordance with an embodiment of the disclosure. FIG. 1C depicts an example uphole time-depth record 106 (travel time vs. depth), and FIG. 1D depicts an interpreted internal velocity vs depth (line 108) based on the example uphole time-depth record.

A direct interpretation of uphole travel time data may be performed by 1) picking first arrival time on the seismic record for different depths of the source, such as shown in FIG. 1B; compiling the travel times vs. depth, as shown in FIG. 1C; estimating the interval velocity by performing the division of the incremental depth interval by the incremental time interval; and 4) compiling the resulting interval velocities in a velocity vs. depth graph, as shown in FIG. 1D.

The travel times versus depth may be interpreted as a log (referred to as “log type”) in which for each sampled depth interval (that is, typically of the order of meter sampling) the corresponding incremental time interval is used in the division. This operation may provide a detailed velocity-depth profile resembling a log. The presence of noise in the time recordings and of different error propagation effects (for example, depth estimation), makes the detailed, log-type, velocity-depth profile unstable and subject to large oscillations of the division generating the interval velocity. Such inferred log-type velocities are typically unusable, as errors in any of these operations will propagate and result in the generation of unreliable calibration velocities.

A typical uphole interpretation may proceed via an operator (human)-based interpretation of travel time “trends”—essentially an upscaling operation in which the interpreter defines sections of the travel time graph where the slope can be approximated by a linear trend. Such a depth interval may then be approximated by one single velocity, as multiple samples within a constant velocity layer generate a linear travel time versus depth behavior with the slope of the linear segments representing a function of the velocity. By way of example, FIG. 2A depicts a travel time vs. depth graph 200 having various identified travel time linear trends, and FIG. 2B depicts a velocity vs. depth function 202 generated from the travel time vs. depth graph 200 of FIG. 2A. As shown in FIGS. 2A and 2B, the depth intervals from the interpreted travel times trends may be represented by single velocity values in the velocity vs. depth function 202.

While this uphole velocity analysis by upscaling and refracted “trends” interpretation is robust to noise and errors in comparison to the log-type interpretation, the limited amount of data points makes the process very subjective and prone to oversimplifications. This produces unreliable calibrations where the amount of upscaling and simplification are related to the human operator and to the level of noise in the data (that is, more noise=more simplification or upscaling).

Embodiments of the disclosure are directed to automatic and robust uphole velocity interpretation that avoid these unreliable calibrations and reduce or eliminate imaging errors and distortions.

In one embodiment, a computer-implemented method is provided for determining uphole velocities of an uphole velocity model from an uphole seismic survey dataset generated from a seismic receiver station configured to sense seismic signals originating from a seismic source station. The method includes obtaining the uphole seismic survey dataset that includes uphole travel times and respective depths, removing anomalous uphole travel times from the uphole travel times to form a refined uphole travel times dataset, and forming a travel times vs depth function based on the refined uphole travel times dataset. The method also includes discretizing the uphole travels times vs. depth function to a plurality of depth intervals, and training a supervised machine learning model using training data that includes a training dataset of synthetic uphole travels times and respective depths. The method further includes determining interval velocities and respective depths for the discretized uphole travel time vs. depth function using the trained machine learning model and determining an uphole velocity model from the interval velocities and respective depths.

In some embodiments, the supervised machine learning model is a feed-forward artificial neural network (ANN). In some embodiments, the method includes generating a seismic image using the uphole velocity model. In some embodiments, forming a travel times vs depth function based on the refined uphole travel times dataset includes fitting the refined uphole travel times dataset by a cubic spline. In some embodiments, the method includes preparing the training dataset of synthetic uphole travels times and respective depths, such that the preparing includes adding random noise to the uphole travels times and respective depths and normalizing the synthetic uphole travels times and respective depths.

In another embodiment, a non-transitory computer-readable storage medium having executable code stored thereon for determining uphole velocities of an uphole velocity model from an uphole seismic survey dataset generated from a seismic receiver station configured to sense seismic signals originating from a seismic source station. The executable code includes a set of instructions that causes a processor to perform operations that include obtaining the uphole seismic survey dataset that includes uphole travel times and respective depths, removing anomalous uphole travel times from the uphole travel times to form a refined uphole travel times dataset, and forming a travel times vs depth function based on the refined uphole travel times dataset. The operations also include discretizing the uphole travels times vs. depth function to a plurality of depth intervals, and training a supervised machine learning model using training data that includes a training dataset of synthetic uphole travels times and respective depths. The operations further include determining interval velocities and respective depths for the discretized uphole travel time vs. depth function using the trained machine learning model and determining an uphole velocity model from the interval velocities and respective depths.

In some embodiments, the supervised machine learning model is a feed-forward artificial neural network (ANN). In some embodiments, the operations include generating a seismic image using the uphole velocity model. In some embodiments, forming a travel times vs depth function based on the refined uphole travel times dataset includes fitting the refined uphole travel times dataset by a cubic spline. In some embodiments, the operations include preparing the training dataset of synthetic uphole travels times and respective depths, such that the preparing includes adding random noise to the uphole travels times and respective depths and normalizing the synthetic uphole travels times and respective depths.

In another embodiment, a system is provided that includes a seismic source station, a seismic receiver station configured to sense seismic signals originating from a seismic source station, a seismic data processor, and a non-transitory computer-readable storage memory accessible by the seismic data processor and having executable code stored thereon for determining uphole velocities of an uphole velocity model from an uphole seismic survey dataset from the seismic signals. The executable code includes a set of instructions that causes a processor to perform operations that include obtaining the uphole seismic survey dataset that includes uphole travel times and respective depths, removing anomalous uphole travel times from the uphole travel times to form a refined uphole travel times dataset, and forming a travel times vs depth function based on the refined uphole travel times dataset. The operations also include discretizing the uphole travels times vs. depth function to a plurality of depth intervals, and training a supervised machine learning model using training data that includes a training dataset of synthetic uphole travels times and respective depths. The operations further include determining interval velocities and respective depths for the discretized uphole travel time vs. depth function using the trained machine learning model and determining an uphole velocity model from the interval velocities and respective depths.

In some embodiments, the supervised machine learning model is a feed-forward artificial neural network (ANN). In some embodiments, the operations include generating a seismic image using the uphole velocity model. In some embodiments, forming a travel times vs depth function based on the refined uphole travel times dataset includes fitting the refined uphole travel times dataset by a cubic spline. In some embodiments, the operations include preparing the training dataset of synthetic uphole travels times and respective depths, such that the preparing includes adding random noise to the uphole travels times and respective depths and normalizing the synthetic uphole travels times and respective depths.

In another embodiment, a computer-implemented method for determining uphole velocities of an uphole velocity model from an uphole seismic survey dataset generated from a seismic receiver station configured to sense seismic signals originating from a seismic source station is provided. The method includes obtaining the uphole seismic survey dataset having uphole travel times and respective depths, removing anomalous uphole travel times from the uphole travel times to form a refined uphole travel times dataset, and forming a travel times vs depth function based on the refined uphole travel times dataset. The method also includes discretizing the uphole travels times vs. depth function to a plurality of depth intervals and segmenting the plurality of depth intervals using a piecewise linear function. The method further includes identifying interval velocities at the corresponding segmented depth intervals and determining an uphole velocity model from the interval velocities at the corresponding segmented depth intervals.

In some embodiments, the method includes generating a seismic image using the uphole velocity model. In some embodiments, forming a travel times vs depth function based on the refined uphole travel times dataset includes fitting the refined uphole travel times dataset by a cubic spline.

In another embodiment, a non-transitory computer-readable storage medium having executable code stored thereon for determining uphole velocities of an uphole velocity model from an uphole seismic survey dataset generated from a seismic receiver station configured to sense seismic signals originating from a seismic source station. The executable code includes a set of instructions that causes a processor to perform operations that include obtaining the uphole seismic survey dataset having uphole travel times and respective depths, removing anomalous uphole travel times from the uphole travel times to form a refined uphole travel times dataset, and forming a travel times vs depth function based on the refined uphole travel times dataset. The operations also include discretizing the uphole travels times vs. depth function to a plurality of depth intervals and segmenting the plurality of depth intervals using a piecewise linear function. The operations further include identifying interval velocities at the corresponding segmented depth intervals and determining an uphole velocity model from the interval velocities at the corresponding segmented depth intervals.

In some embodiments, the operations include generating a seismic image using the uphole velocity model. In some embodiments, forming a travel times vs depth function based on the refined uphole travel times dataset includes fitting the refined uphole travel times dataset by a cubic spline.

In another embodiment, a system is provided that includes a seismic source station, a seismic receiver station configured to sense seismic signals originating from a seismic source station, a seismic data processor, and a non-transitory computer-readable storage memory accessible by the seismic data processor and having executable code stored thereon for determining uphole velocities of an uphole velocity model from an uphole seismic survey dataset from the seismic signals. The executable code includes a set of instructions that causes a processor to perform operations that include obtaining the uphole seismic survey dataset having uphole travel times and respective depths, removing anomalous uphole travel times from the uphole travel times to form a refined uphole travel times dataset, and forming a travel times vs depth function based on the refined uphole travel times dataset. The operations also include discretizing the uphole travels times vs. depth function to a plurality of depth intervals and segmenting the plurality of depth intervals using a piecewise linear function. The operations further include identifying interval velocities at the corresponding segmented depth intervals and determining an uphole velocity model from the interval velocities at the corresponding segmented depth intervals.

In some embodiments, the operations include generating a seismic image using the uphole velocity model. In some embodiments, forming a travel times vs depth function based on the refined uphole travel times dataset includes fitting the refined uphole travel times dataset by a cubic spline.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A and 1B depict a schematic of an uphole survey in accordance with an embodiment of the disclosure;

FIGS. 1C and 1D depicts results from an uphole survey as illustrated by FIGS. 1A and 1B;

FIG. 2A depicts a travel time vs. depth graph having various identified travel time linear trends;

FIG. 2B depicts a velocity vs. depth function 202 generated from the travel time vs. depth graph of FIG. 2A;

FIG. 3 depicts a process for determining a velocity model from uphole seismic survey data using a statistical approach in accordance with an embodiment of the disclosure;

FIG. 4A depicts a graph of depth (in meters (m)) vs. travel time (in milliseconds (ms)) in accordance with an embodiment of the disclosure;

FIG. 4B depicts a graph of depth (in m) vs. velocity (in m/s) showing a depth vs. velocity function having interval velocities interpreted from the depth intervals of FIG. 4A in accordance with an embodiment of the disclosure;

FIG. 5 depicts a process for constructing an uphole velocity model from uphole seismic survey data using a machine learning (ML) model in accordance with an embodiment of the disclosure.

FIG. 6 depicts a schematic diagram of a neural network in accordance with an embodiment of the disclosure;

FIG. 7 depicts an example of the processing of inputs by a neural network in accordance with an embodiment of the disclosure;

FIG. 8 depicts a schematic diagram illustrating neural network processing in accordance with an embodiment of the disclosure;

FIG. 9 depicts a system for determining an uphole velocity model from uphole seismic survey data in accordance with an embodiment of the disclosure;

FIG. 10 depicts components of a seismic data processing computer in accordance with an embodiment of the disclosure;

FIGS. 11A-11D depict scatter plots of output values vs. target values illustrating a computed correlation on example training, testing, and validation subsets, and on the combination of data in accordance with an embodiment of the disclosure;

FIG. 12A is a plot of synthetic uphole travel time data (depth vs. travel time) unseen by an example trained neural network in accordance with an embodiment of the disclosure.

FIG. 12B is a graph of the corresponding predicted velocities from the data of FIG. 12A using the example trained neural network in accordance with an embodiment of the disclosure;

FIG. 12C is a plot of synthetic uphole travel time data (depth vs. travel time) unseen by the example trained neural network and having added noise as compared to the data of FIG. 12A;

FIG. 12D is a graph of the corresponding predicted velocities from the data of FIG. 12C using the example trained neural network in accordance with an embodiment of the disclosure;

FIG. 13 depicts the application of the trained neural network to the automatic interpretation of the field uphole data used in FIG. 4A in accordance with an embodiment of the disclosure; and

FIG. 14 is 3D model of a near-surface FWI velocity model and the output from the example trained neural network model (as colored vertical functions in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure are directed to constructing a velocity model (also referred to as a “velocity profile”) from uphole seismic survey data using a statistical approach or a machine learning (ML) model. The uphole travel time vs. depth data from the uphole seismic survey is processed by fitting a smoothing function and removing outliers to form an uphole travel time vs. depth function that is then discretized to depth intervals. In the statistical approach, the discretized uphole travel time vs. depth function is segmented by piecewise linear functions, and the linear segments are used to interpret the interval velocities at the corresponding depth intervals. In the machine learning approach, a machine learning model is trained using synthetic uphole travel time data. The trained machine learning model is provided to determine interval velocities from the uphole travel time vs. depth data from the uphole seismic survey. A velocity model having velocity vs. depth is obtained from the interval velocities.

FIG. 3 depicts a process 300 for determining a velocity model from uphole seismic survey data using a statistical approach in accordance with an embodiment of the disclosure. Initially, an uphole seismic survey dataset that includes seismic data is obtained for an area of interest (block 302). As known the art, the seismic data may include seismic exploration data having uphole (that is, vertical) travel times.

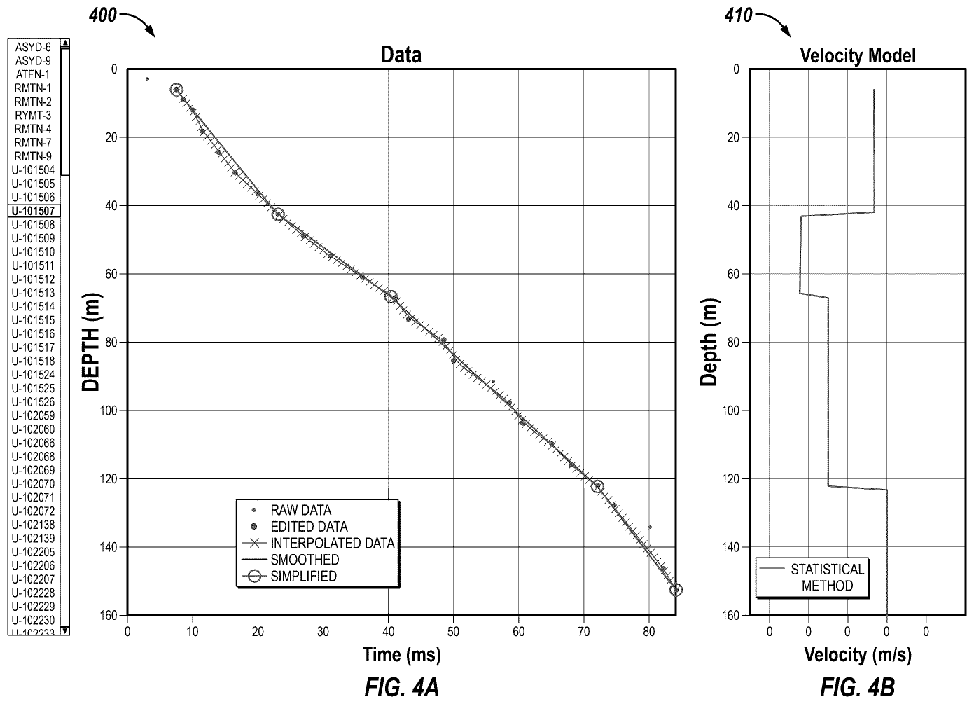

Next, the uphole travel time vs. depth data from the uphole seismic survey dataset may be fit (block 304) to a cubic spline or other smoothing function. FIG. 4A depicts a graph 400 of depth (in meters (m)) vs. travel time (in milliseconds (ms)) in accordance with an embodiment of the disclosure. The fitted uphole vs travel time function is depicted by “smoothed” data (blue line 402) in FIG. 4A. Outliers may then be removed from the uphole travel time vs. depth data (block 306). The travel times may be analyzed to determine a statistical measure of “mean,” “median,” or other statistical quantity that may be defined for the removal of outliers (for example, uphole travel times greater than a certain standard deviation). An example of determined outliers is illustrated by the “raw data” (red dots 404) in FIG. 4A.

As shown in FIG. 3, the uphole travel time vs depth function may then be discretized to depth intervals (block 308). An example of a discretized function is depicted as interpolated data (line 406) in FIG. 6. Next, the depth interval samples may be segmented by piecewise linear functions (block 310). In some embodiments, the piecewise linear functions may be parameterized via user input. An example of segmented depth intervals are depicted in FIG. 4A as “simplified data” (line 408).

The linear segments may then be used to interpret the interval velocities at the corresponding depth intervals (block 312). For example, FIG. 4B depicts a graph 410 of depth (in m) vs. velocity (in m/s) showing a depth vs. velocity function 412 having interval velocities interpretated from the depth intervals of FIG. 4A in accordance with an embodiment of the disclosure. The interval velocities and depth vs. velocity function may be used to obtain velocity profiles vs. depth for an uphole velocity model (block 314). After generation of the uphole velocity model, a seismic image for the area of interest may be generated. The seismic images produced from the seismic image data may be used identify subsurface mineral deposits in a geological structure and determine locations for drilling a well in the geological structure.

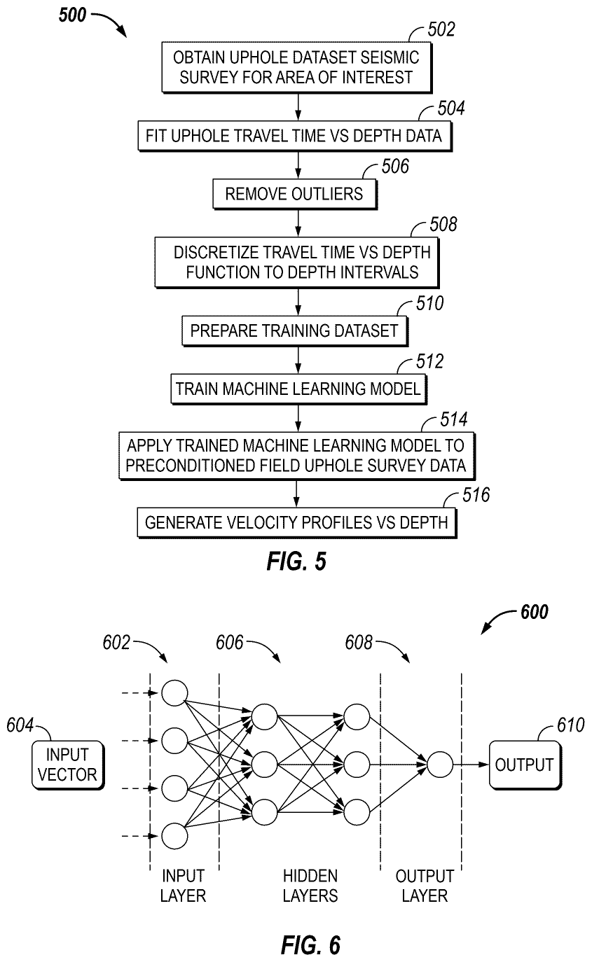

In another embodiment, the uphole velocity model may be determined using a machine learning (ML) model. FIG. 5 depicts a process 500 for constructing an uphole velocity model from uphole seismic survey data using a machine learning (ML) model in accordance with an embodiment of the disclosure. Initially, an uphole seismic survey dataset that includes seismic data is obtained for an area of interest (block 502). As known the art, the seismic data may include seismic exploration data having uphole (that is, vertical) travel times.

As shown in FIG. 5, the uphole travel time vs. depth data may be fit (block 504) to a cubic spline or other smoothing function. Next, outliers are removed from the uphole travel time vs. depth data (block 506). The travel times may be analyzed to determine a statistical measure of “mean,” “median,” or other statistical quantity that may be defined for the removal of outliers (for example, uphole travel times greater than a certain standard deviation). The uphole travel time vs depth function may then be discretized to depth intervals (block 508) for use with the ML model.

As shown in FIG. 5, a training dataset may be prepared (block 510). In some embodiments, the training may include a regularization step as described in the disclosure. In some embodiments having limited access to extensive field uphole survey data training dataset may be a synthetically generated uphole survey. For example, a typical training dataset for embodiment of the disclosure may include at least 40,000 velocity depth profiles generated from realistic statistical distributions using uphole data modeling, although other training datasets may include more or less velocity depth profiles. Corresponding uphole travel times may then be computed by using the velocity and thickness values for each vertical profile. In some embodiments, the uphole simulation of the model for the synthetic uphole survey may be performed down to at least 1000 m depth. In some embodiments, preparation of the synthetic uphole survey may also include the perturbation of the simulated uphole time-depth information by adding random noise. In some embodiments, at least 5% random noise may be added. This noise incorporation during the training phase of the neural network (referred to as “regularization”) may improve its performance and avoid the problem of overfitting. The perturbed uphole travel time samples may be provided to the neural network as training inputs, with the generated interval velocity profiles serving as desired outputs for training.

In some embodiments, preparing the training data may include additional data conditioning, such as normalizing the training input and output variables. The data normalization may ensure that the training dataset shares a common scale, resulting in increased efficiency and stability of the model by facilitating a faster convergence and reducing the probability of being trapped in local minima. In some embodiments, the data normalization may include data rescaling (also referred to as min-max normalization), which linearly transforms the inputs and the targets in the range [−1,1]. Such a data rescaling may be expressed as follows:

After preparing the training data, the training dataset may be split into three subsets: training, validation, and testing. In some embodiments, the training subset is 70% of the training dataset, the validation subset is 15% of the training dataset, and the testing subset is 15% of the training dataset. In the example synthetic dataset described herein, each training input includes a travel time vector of one uphole survey, sampled every 2 meters in the depth dimension. The corresponding target consists of a velocity vector, irregularly sampled to accommodate fine sampling at the shallow depths with coarser sampling towards the deeper section.

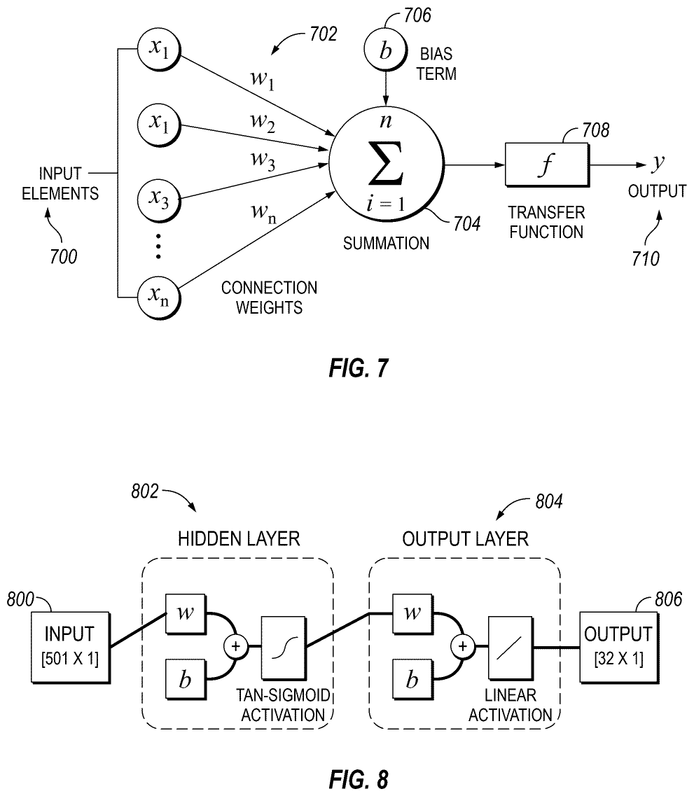

Next, an ML model may be selected and trained with the prepared synthetic training data (block 512). The trained ML model may then be used to make predictions about unseen (that is, new) data. In some embodiments, the machine learning model may be an artificial neural network having multiple nodes (also referred to as “neurons”) and one or more layers: an input layer, one or more hidden layers, and an output layer. By way of example, FIG. 6 depicts a schematic diagram of a neural network 600 having an input layer 602 that receives an input 604, one or more hidden layers 606, and an output layer 608 that provides an output 610 in accordance with an embodiment of the disclosure. The neurons may be connected through modifiable connection weights that modulate the influence of each input to the neuron upon the output. In addition to the weighted inputs, each neuron may include a bias and a nonlinear transfer function. FIG. 7 depicts an example of the processing of inputs by a neural network in accordance with an embodiment of the disclosure. As shown in FIG. 7, input elements 700 (denoted as x₁, x₂, x₃ . . . xₙ) may be assigned connection weights 702 (denoted as w₁, w₂, w₃ . . . wₙ). After the raw input elements 700 are passed by the input layer to the subsequent hidden layer, each neuron within that layer processes the information by summing the weighted inputs (summation 704), followed by adding a bias 706 and applying a transfer function 708 to form a scalar output 710. This process is then repeated by transmitting the outputs as inputs to the subsequent processing layer until the final (that is, output) layer is reached. For a neural network with n number of input elements, the output signal y of a neuron may be expressed as:

$$y = f ( {Σ}_{i = 1}^{n} {w}_{i} {x}_{i} + b ) \qquad ( 1 )$$

where xᵢ denotes the input vector, wᵢ denotes the associated connection weight vector, b is the bias term and f represents the transfer function (also known as the activation function). In some embodiments, the ANN is a feedforward neural network that transfers the information in a forward direction: from the input layer to the output layer. The training of the supervised neural network may include randomly initializing all weights and biases, then feeding the neural network with the training dataset (that is a set of labeled inputs and desired outputs). The data is processed as described supra to determine output results, which are then compared against the desired outputs. The mismatch between the actual outputs and the predicted outputs is calculated through an error function and propagated back to the neural network to adjust its parameters (that is, weights and biases). This process is repeated until an acceptable accuracy is achieved.

In some embodiments, the neural network is designed based on a shallow architecture (a neural network with one or two hidden layers). In some embodiments, the neural network includes a single hidden layer. In some embodiments having a single hidden layer, the hidden layer may include 30 neurons and may use a tan-sigmoid activation function; the output layer may include a linear transfer function. FIG. 8 depicts a schematic diagram illustrating neural network processing via an input (501×1 dimension) 800, a hidden layer 802 with a tan-sigmoid activation function, an output layer 804 with a linear transfer function, and an output (32×1 dimension) 806 in accordance with an embodiment of the disclosure.

In some embodiments, the neural network may use a minimization optimizer for the training algorithm, such as Levenberg-Marquardt back-propagation optimization. In some embodiments, the performance of the trained neural network may be evaluated by computing the cross-correlation coefficient (R), the root-mean-square error (RMSE), or other performance metrics.

As shown in FIG. 5, the trained ML model may then be applied to the uphole seismic survey data to output interval velocities vs. depth (block 514). For example, the trained ML model may receive as input the discretized uphole travel time vs. depth function (block 508). The interval velocities and respective depths may be used to obtain velocity profiles vs. depth for an uphole velocity model depth (block 516). After generation of the uphole velocity model, a seismic image for the area of interest may be generated. The seismic images produced from the seismic image data may be used identify subsurface mineral deposits in a geological structure and determine locations for drilling a well in the geological structure.

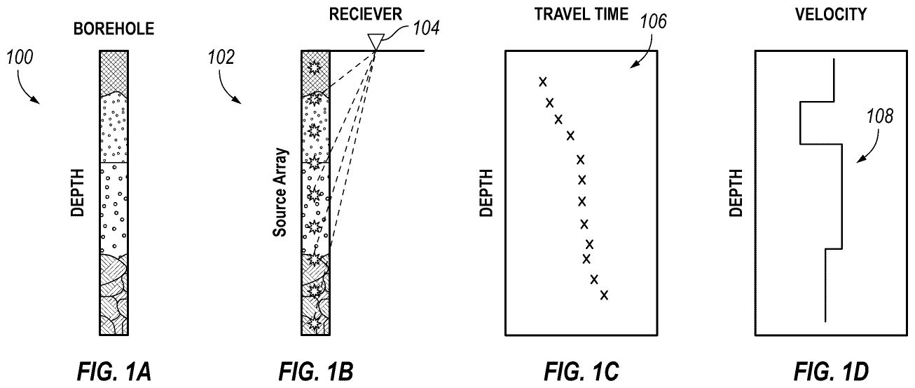

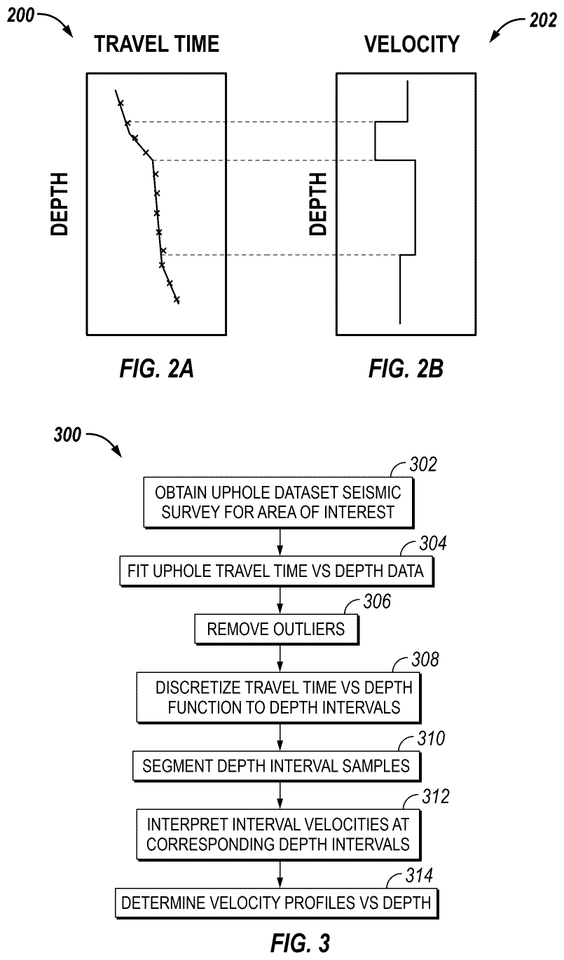

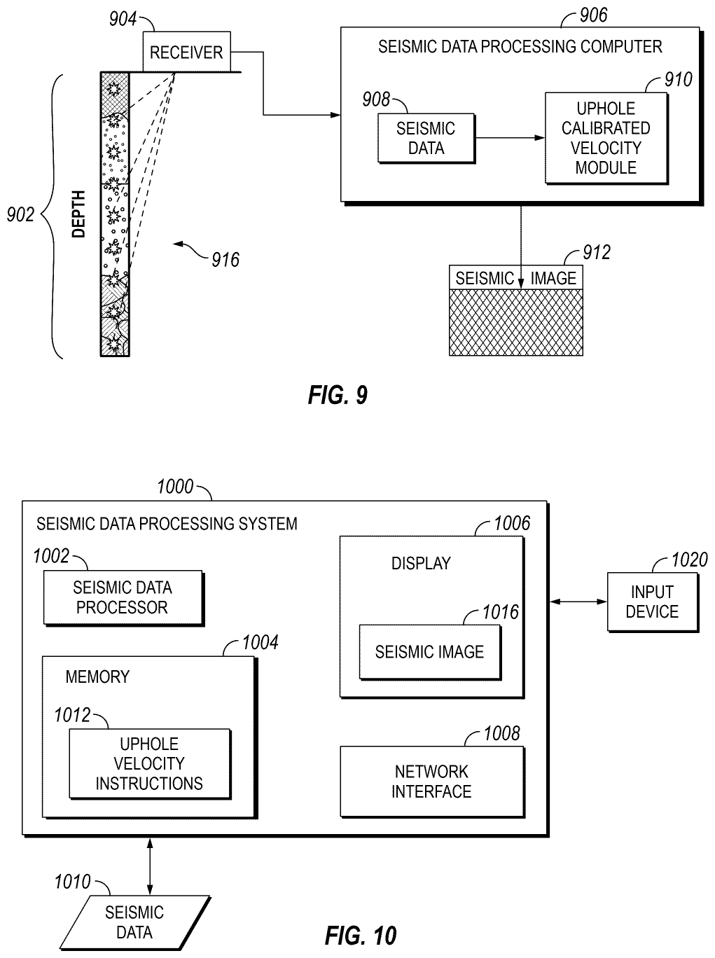

FIG. 9 depicts a system 900 for generating a velocity model from uphole seismic survey data using a statistical approach or a machine learning model in accordance with an embodiment of the disclosure. The system 900 can include, for example, a seismic source array 902 (also referred to as a “seismic station” array), one or more seismic receivers 904 (also referred to as “receiver stations”) arranged in the manner illustrated in FIG. 1B and discussed supra. The seismic receivers 604 may also be represented by a fiber optic cable for distributed acoustic sensing (DAS). It should be noted that placing receivers in the borehole and sources on the surface has exactly the same effect as travel times and wave propagation follow the principle of reciprocity. The system 900 may also include a seismic data processing computer 906 that stores and processes uphole seismic survey data 908, such as a shot gather responsive to seismic energy signals received by the seismic receiver, and uphole velocity module 910 that constructs an uphole velocity model from the uphole seismic survey data 908. Additionally, the seismic data processing computer 906 may produce a seismic image 912 from seismic data as is known in the art. According to various embodiments of the present disclosure, the seismic source array 902 can include any seismic or acoustic energy whether from an explosive, implosive, swept-frequency or random sources. The seismic source, for example, can generate a seismic energy signal that propagates into the earth 916.

Generally, the seismic source array 902 can emit seismic waves into the earth 916 to evaluate subsurface conditions and to detect possible concentrations of oil, gas, and other subsurface minerals. Seismic waves may travel through an elastic body (such as the earth 916). The propagation velocity of seismic waves may depend on the particular elastic medium through which the waves travel, particularly the density and elasticity of the medium as is known and understood by those skilled in the art. The refraction or reflection of seismic waves onto the one or more seismic receivers 904 can be used to research and investigate subsurface structures of the earth 916. Embodiments of the system 900 may include a plurality of seismic sources arranged in an array.

Accordingly, the one or more seismic receivers 904 can be positioned to receive and record seismic energy data or seismic field records in any form including, but not limited to, a geophysical time series recording of the acoustic reflection and refraction of waveforms that travel from the seismic source array 902 to the one or more seismic receivers 904. Variations in the travel times of reflection and refraction events in one or more field records in seismic data processing can produce seismic data 908 that demonstrates subsurface structures and enables the identification of discontinuities in accordance with the embodiment described in the disclosure. Seismic images produced from the seismic image data may be used to aid in the search for, and exploitation of, subsurface mineral deposits in the geological structure.

Generally speaking, the one or more seismic receivers 904 can record sound wave echoes (otherwise known as seismic energy signal reflections) that come back up through the ground from a seismic source array 902 to a recording surface. Such seismic receivers 904 can record the intensity of such sound waves and the time it took for the sound wave to travel from the seismic source array 902 back to the one or more seismic receivers 904 at the recording surface. According to embodiments of the present disclosure, for example, during the seismic imaging process, the reflections of sound waves emitted by a seismic source array 902, and recorded by a seismic energy recording 904, can be processed by a computer to detect faults in the present in the earth 916. The detected faults and resulting seismic image of the subsurface can be used to identify, for example, the placement of wells and potential well flow paths.

More specifically, the term seismic receiver 904 as is known and understood by those skilled in the art, can include geophones, hydrophones and other sensors designed to receive and record seismic energy. Accordingly, by placing a plurality of geophone seismic receivers 904 at a recording surface, a two-dimensional seismic image can be produced responsive to seismic data recorded by the geophone seismic receivers. Embodiments of the system 900 may include a designated spacing between each receiver of the one or more receivers 904. In some embodiments, the seismic receiver 604 may be implemented with distributed acoustic sensing (DAS) using a fiber optic cable.

According to an embodiment of the present disclosure, the one or more seismic receivers 904 can be positioned to receive and record seismic energy data or seismic field records in any form including a geophysical time series recording of the acoustic reflection and refraction of waveforms that travel from the seismic source array 902 to the one or more seismic receivers 904. Variations in the travel times of reflection and refraction events in one or more field records in a plurality of seismic signals can, when processed by the seismic data processing computer 906, produce seismic data 908 that demonstrates subsurface structure. As described herein, prior to using a seismic data 908 to aid in the search for, and exploitation of, mineral deposits, the seismic data 908 may be processed to construct an uphole velocity model from uphole seismic survey data using a machine learning model. The interpretation of the seismic image 912 generated from such data may be used to determine the location of wells drilling into the earth 916. Thus, one or more drills may be drilled into the earth 916 in response to the generation and interpretation of the seismic image 912.

FIG. 10 depicts components of a seismic data processing computer 1000 in accordance with an embodiment of the disclosure. In some embodiments, seismic data processing computer 1000 may be in communication with other components of a system for obtaining and producing seismic data. Such other components may include, for example, seismic shot stations (sources) and seismic receiving stations (receivers). As shown in FIG. 10, the seismic data processing computer 1000 may include a seismic data processor 1002, a memory 1004, a display 1006, and a network interface 1008. It should be appreciated that the seismic data processing computer 1000 may include other components that are omitted for clarity. In some embodiments, seismic data processing computer 1000 may include or be a part of a computer cluster, cloud-computing system, a data center, a server rack or other server enclosure, a server, a virtual server, a desktop computer, a laptop computer, a tablet computer, or the like.

The seismic data processor 1002 (as used the disclosure, the term “processor” encompasses microprocessors) may include one or more processors having the capability to receive and process seismic data, such as data received from seismic receiving stations. In some embodiments, the seismic data processor 1002 may include an application-specific integrated circuit (AISC). In some embodiments, the seismic data processor 1002 may include a reduced instruction set (RISC) processor. Additionally, the seismic data processor 1002 may include a single-core processors and multicore processors and may include graphics processors. Multiple processors may be employed to provide for parallel or sequential execution of one or more of the techniques described in the disclosure. The seismic data processor 1002 may receive instructions and data from a memory (for example, memory 1004).

The memory 1004 (which may include one or more tangible non-transitory computer readable storage mediums) may include volatile memory, such as random access memory (RAM), and non-volatile memory, such as ROM, flash memory, a hard drive, any other suitable optical, magnetic, or solid-state storage medium, or a combination thereof. The memory 1004 may be accessible by the seismic data processor 1002. The memory 1004 may store executable computer code. The executable computer code may include computer program instructions for implementing one or more techniques described in the disclosure. For example, in some embodiments the executable computer code may include uphole velocity model instructions 1012 that define an uphole velocity module having a machine learning model to implement embodiments of the present disclosure. In some embodiments, the uphole velocity instructions 1012 may implement one or more elements of process 300 described above and illustrated in FIG. 3, or the process 500 described above and illustrated in FIG. 5. In some embodiments, the uphole velocity instructions 1012 may receive, as input, seismic data 1010 and may produce, as output, an identification of faults in the seismic data. In some embodiments, a seismic image 1016 may be produced, stored in the memory 1004 and, as shown in FIG. 10, displayed on the display 1006.

The display 1006 may include a cathode ray tube (CRT) display, liquid crystal display (LCD), an organic light emitting diode (OLED) display, or other suitable display. The display 1006 may display a user interface (for example, a graphical user interface) that may display information received from the plant information processing computer 1006. In accordance with some embodiments, the display 1006 may be a touch screen and may include or be provided with touch sensitive elements through which a user may interact with the user interface.

The network interface 1008 may provide for communication between the seismic data processing computer 1000 and other devices. The network interface 1008 may include a wired network interface card (NIC), a wireless (for example, radio frequency) network interface card, or combination thereof. The network interface 1008 may include circuitry for receiving and sending signals to and from communications networks, such as an antenna system, an RF transceiver, an amplifier, a tuner, an oscillator, a digital signal processor, and so forth. The network interface 1008 may communicate with networks, such as the Internet, an intranet, a wide area network (WAN), a local area network (LAN), a metropolitan area network (MAN) or other networks. Communication over networks may use suitable standards, protocols, and technologies, such as Ethernet Bluetooth, Wireless Fidelity (Wi-Fi) (for example, IEEE 802.11 standards), and other standards, protocols, and technologies. In some embodiments, for example, the unprocessed seismic data 1010 may be received over a network via the network interface 1008. In some embodiments, for example, the seismic image 1016 may be provided to other devices over the network via the network interface 1008.

In some embodiments, seismic data processing computer may be coupled to an input device 1020 (for example, one or more input devices). The input devices 1020 may include, for example, a keyboard, a mouse, a microphone, or other input devices. In some embodiments, the input device 1020 may enable interaction with a user interface displayed on the display 1006. For example, in some embodiments, the input devices 1020 may enable the entry of inputs that control the acquisition of seismic data, the processing of seismic data, and so on.

### EXAMPLES

The following examples are included to demonstrate embodiments of the disclosure. It should be appreciated by those of skill in the art that the techniques and compositions disclosed in the example which follows represents techniques and compositions discovered to function well in the practice of the disclosure, and thus can be considered to constitute modes for its practice. However, those of skill in the art should, in light of the present disclosure, appreciate that many changes can be made in the specific embodiments which are disclosed and still obtain a like or a similar result without departing from the spirit and scope of the disclosure.

The performance of an example neural network trained using a synthetic dataset according to the techniques described in the disclosure was assessed by providing a measure of similarity between the actual and predicted variables via the correlation coefficient R. As will be appreciated, the value of R ranges between −1 and 1, with 1 indicating a perfect correlation.

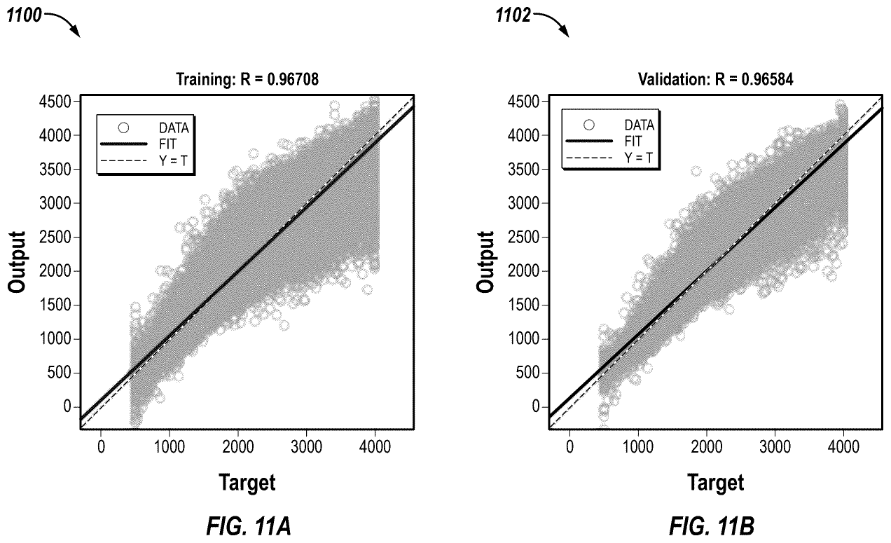

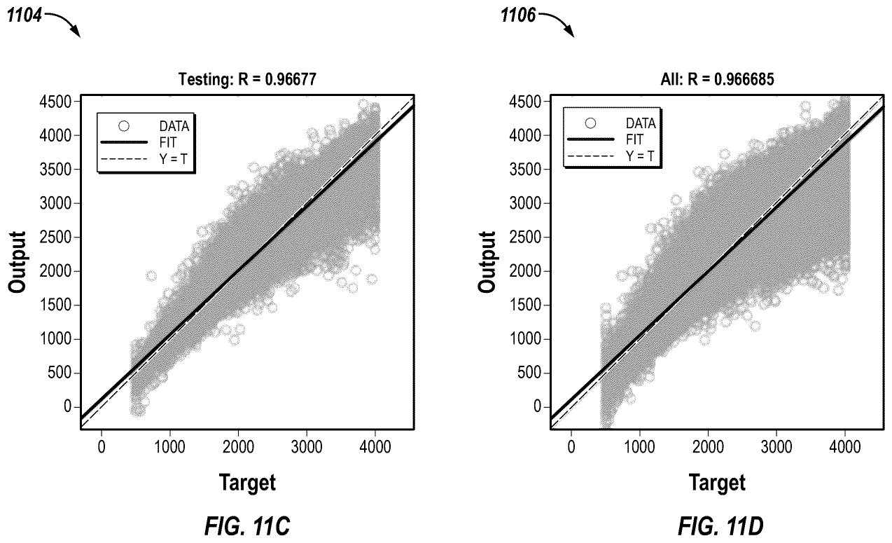

FIGS. 11A-11D depict scatter plots of output values vs. target values illustrating the correlation on example training, testing, and validation subsets, and on the combination of data using the example trained neural network. For example, FIG. 11A depicts a scatter plot 1100 of output values vs. target values for a training dataset showing an R value of 0.96708, FIG. 11B depicts a scatter plot 1102 of output values vs. target values for a validation dataset showing an R value of 0.96584, FIG. 11C depicts a scatter plot 1104 of output values vs. target values for a testing dataset showing an R value of 0.96677, and FIG. 11D depicts a scatter plot 1106 of output values vs. target values for a combination of the training, validation, and testing datasets and shows an R value of 0.96685. As shown in FIGS. 11A-11D, all subsets exhibit strongly correlated pairs of actual and predicted velocity values. The RMSE for the example trained neural network was computed as 203 m/s.

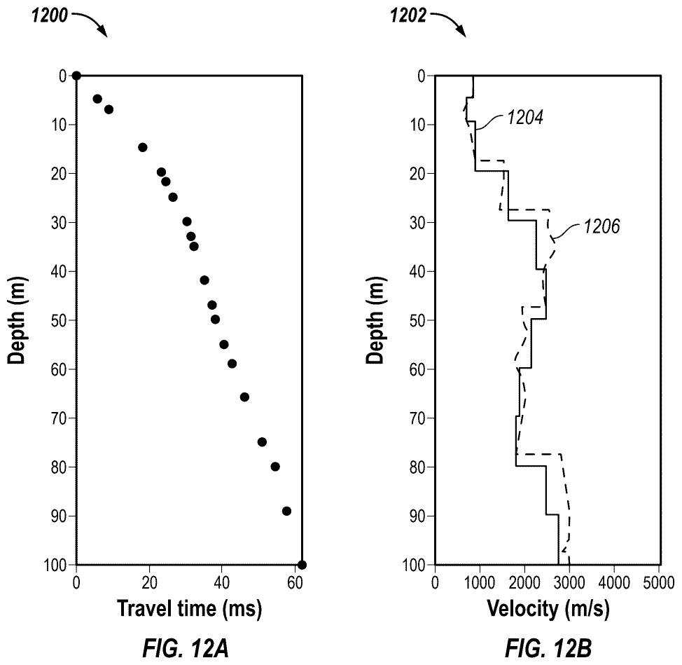

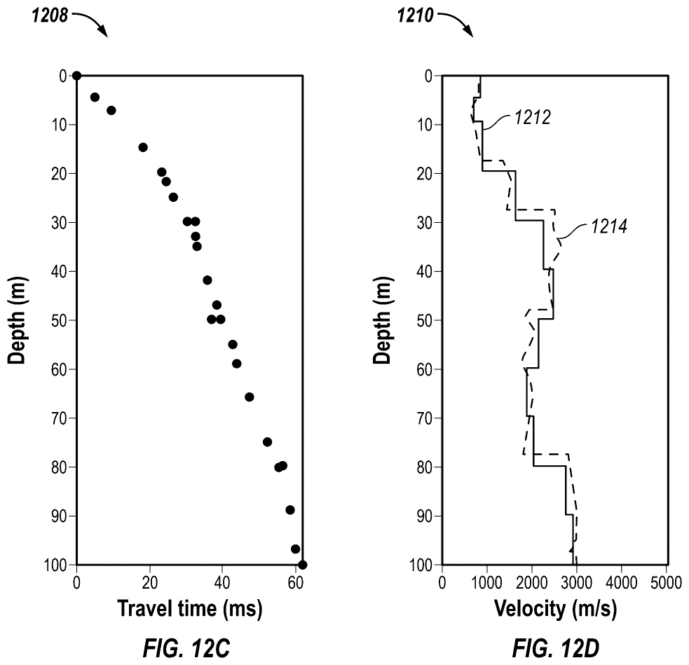

The example trained neural network was tested on synthetic uphole datasets and field uphole datasets. FIG. 12A is a plot 1200 of synthetic uphole travel time data (depth vs. travel time) unseen by the example trained neural network. FIG. 12B is a graph 1202 of the corresponding predicted velocities (line 1204) from data of FIG. 12A using the example trained neural network. FIG. 12B also depicts the true interval velocity (dashed line 1206) for comparison. As shown in these figures, the trained neural network produces a velocity model having a good match with the actual velocity profile.

In another example, FIG. 12C is a plot 1208 of synthetic uphole travel time data (depth vs. travel time) unseen by the example trained neural network and having added noise as compared to the data of FIG. 12A. FIG. 12D is a graph 1210 of the corresponding predicted velocities (line 1212) from the data of FIG. 12C using the example trained neural network. FIG. 12D also depicts the true interval velocity (line 1214) for comparison. As shown in these figures, the trained neural network remains capable of producing a velocity model comparable to the actual velocity profile, demonstrating its ability to robustly handle data with various levels of noise.

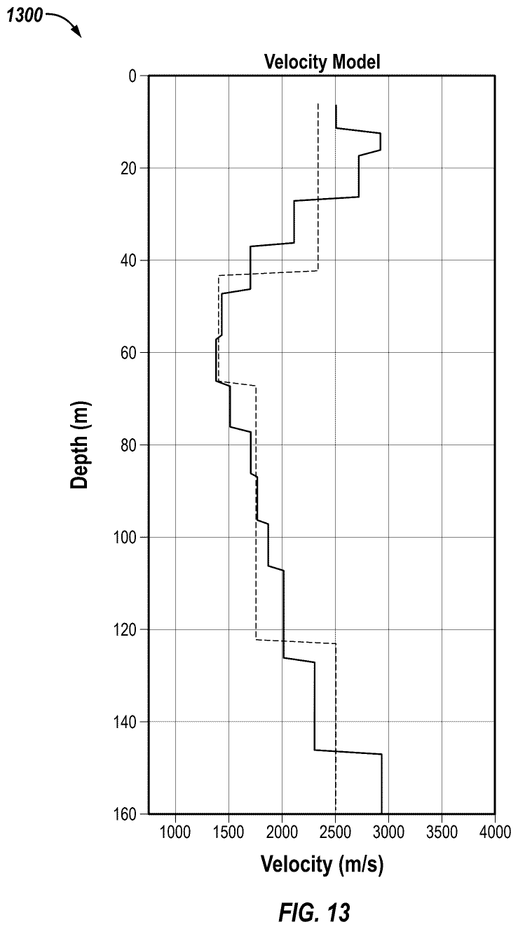

Additionally, the trained neural network was used on field uphole data to evaluate its performance. FIG. 13 depicts the application of the trained neural network to the automatic interpretation of the field uphole data used in FIG. 4A in accordance with an embodiment of the disclosure. FIG. 13 is a graph 1300 of depth (in m) vs. velocity (m/s) showing the velocity model (line 1302) predicted by the example trained neural network and the velocity model (line 1304) output from the statistical process described supra and illustrated in FIG. 4B. As shown in FIG. 13, the trained neural network outputs a velocity model having relatively high accuracy while maintaining the overall stability of the results.

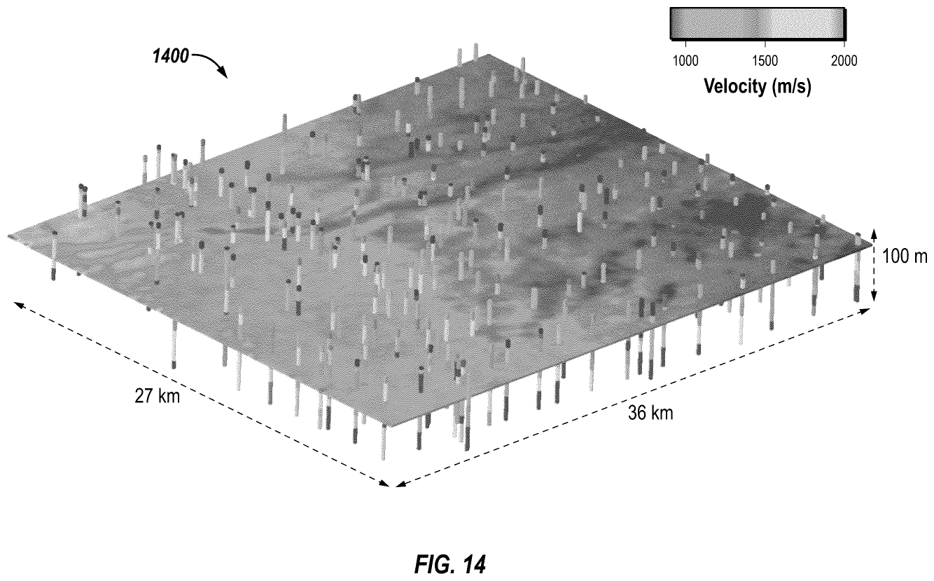

The example trained neural network was applied for the prediction of the interval velocity models from 242 uphole field data. The results were compared against a high-resolution near-surface velocity depth slice obtained through full waveform inversion (FWI). FIG. 14 is 3D model 1400 of the near-surface FWI velocity model and the output from the example trained neural network model (as the colored vertical functions), with the velocity values indicated according to color legend 1402 in accordance with an embodiment of the disclosure. As shown in FIG. 14, the automatically generated uphole velocity profiles using the trained neural network model show consistent spatial responses and agreement with the FWI model. This performance is more evident in the western part (left portion of the model) where the interpreted upholes indicate higher near-surface velocities consistent with the FWI model.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A computer-implemented method for determining uphole velocities of an uphole velocity model from an uphole seismic survey dataset generated from a seismic receiver station configured to sense seismic signals originating from a seismic source station, the method comprising:
obtaining the uphole seismic survey dataset comprising uphole travel times and respective depths;
removing anomalous uphole travel times from the uphole travel times to form a refined uphole travel times dataset;
forming a travel times vs depth function based on the refined uphole travel times dataset;
discretizing the uphole travels times vs. depth function to a plurality of depth intervals;
training a supervised machine learning model using training data comprising a training dataset of synthetic uphole travels times and respective depths;
determining interval velocities and respective depths for the discretized uphole travel time vs. depth function using the trained machine learning model; and
determining an uphole velocity model from the interval velocities and respective depths.

2. The method of claim 1, wherein the supervised machine learning model comprises a feed-forward artificial neural network (ANN).

3. The method of claim 1, comprising generating a seismic image using the uphole velocity model.

4. The method of claim 1, wherein forming a travel times vs depth function based on the refined uphole travel times dataset comprises fitting the refined uphole travel times dataset by a cubic spline.

5. The method of claim 1, comprising preparing the training dataset of synthetic uphole travels times and respective depths, the preparing comprising:
adding random noise to the uphole travels times and respective depths; and
normalizing the synthetic uphole travels times and respective depths.

6. A non-transitory computer-readable storage medium having executable code stored thereon for determining uphole velocities of an uphole velocity model from an uphole seismic survey dataset generated from a seismic receiver station configured to sense seismic signals originating from a seismic source station, the executable code comprising a set of instructions that causes a processor to perform operations comprising:
obtaining the uphole seismic survey dataset comprising uphole travel times and respective depths;
removing anomalous uphole travel times from the uphole travel times to form a refined uphole travel times dataset;
forming a travel times vs depth function based on the refined uphole travel times dataset;
discretizing the uphole travels times vs. depth function to a plurality of depth intervals;
training a supervised machine learning model using training data comprising a training dataset of synthetic uphole travels times and respective depths;
determining interval velocities and respective depths for the discretized uphole travel time vs. depth function using the trained machine learning model; and
determining an uphole velocity model from the interval velocities and respective depths.

7. The non-transitory computer-readable storage medium of claim 6, wherein the supervised machine learning model comprises a feed-forward artificial neural network (ANN).

8. The non-transitory computer-readable storage medium of claim 6, the operations comprising generating a seismic image using the uphole velocity model.

9. The non-transitory computer-readable storage medium of claim 6, wherein forming a travel times vs depth function based on the refined uphole travel times dataset comprises fitting the refined uphole travel times dataset by a cubic spline.

10. The non-transitory computer-readable storage medium of claim 6, the operations comprising preparing the training dataset of synthetic uphole travels times and respective depths, the preparing comprising:
adding random noise to the uphole travels times and respective depths; and
normalizing the synthetic uphole travels times and respective depths.

11. A system, comprising:
a seismic source station;
a seismic receiver station configured to sense seismic signals originating from a seismic source station;
a seismic data processor;
a non-transitory computer-readable storage memory accessible by the seismic data processor and having executable code stored thereon for determining uphole velocities of an uphole velocity model from an uphole seismic survey dataset from the seismic signals, the executable code comprising a set of instructions that causes the seismic data processor to perform operations comprising:
obtaining the uphole seismic survey dataset comprising uphole travel times and respective depths;
removing anomalous uphole travel times from the uphole travel times to form a refined uphole travel times dataset;
forming a travel times vs depth function based on the refined uphole travel times dataset;
discretizing the uphole travels times vs. depth function to a plurality of depth intervals;
training a supervised machine learning model using training data comprising a training dataset of synthetic uphole travels times and respective depths;
determining interval velocities and respective depths for the discretized uphole travel time vs. depth function using the trained machine learning model; and
determining an uphole velocity model from the interval velocities and respective depths.

12. The system of claim 11, wherein the supervised machine learning model comprises a feed-forward artificial neural network (ANN).

13. The system of claim 11, the operations comprising generating a seismic image using the uphole velocity model.

14. The system of claim 11, wherein forming a travel times vs depth function based on the refined uphole travel times dataset comprises fitting the refined uphole travel times dataset by a cubic spline.

15. The system of claim 11, the operations comprising preparing the training dataset of synthetic uphole travels times and respective depths, the preparing comprising:
adding random noise to the uphole travels times and respective depths; and
normalizing the synthetic uphole travels times and respective depths.

16. A computer-implemented method for determining uphole velocities of an uphole velocity model from an uphole seismic survey dataset generated from a seismic receiver station configured to sense seismic signals originating from a seismic source station, the method comprising:
obtaining the uphole seismic survey dataset comprising uphole travel times and respective depths;
removing anomalous uphole travel times from the uphole travel times to form a refined uphole travel times dataset;
forming a travel times vs depth function based on the refined uphole travel times dataset;
discretizing the uphole travels times vs. depth function to a plurality of depth intervals;
segmenting the plurality of depth intervals using a piecewise linear function;
identifying interval velocities at the corresponding segmented depth intervals; and
determining an uphole velocity model from the interval velocities at the corresponding segmented depth intervals.

17. The method of claim 16, comprising generating a seismic image using the uphole velocity model.

18. The method of claim 16, wherein forming a travel times vs depth function based on the refined uphole travel times dataset comprises fitting the refined uphole travel times dataset by a cubic spline.

19. A non-transitory computer-readable storage medium having executable code stored thereon for determining uphole velocities of an uphole velocity model from an uphole seismic survey dataset generated from a seismic receiver station configured to sense seismic signals originating from a seismic source station, the executable code comprising a set of instructions that causes a processor to perform operations comprising:
obtaining the uphole seismic survey dataset comprising uphole travel times and respective depths;
removing anomalous uphole travel times from the uphole travel times to form a refined uphole travel times dataset;
forming a travel times vs depth function based on the refined uphole travel times dataset;
discretizing the uphole travels times vs. depth function to a plurality of depth intervals;
segmenting the plurality of depth intervals using a piecewise linear function;
identifying interval velocities at the corresponding segmented depth intervals; and
determining an uphole velocity model from the interval velocities at the corresponding segmented depth intervals.

20. The non-transitory computer-readable storage medium of claim 19, the operations comprising generating a seismic image using the uphole velocity model.

21. The non-transitory computer-readable storage medium of claim 19, wherein forming a travel times vs depth function based on the refined uphole travel times dataset comprises fitting the refined uphole travel times dataset by a cubic spline.

22. A system, comprising:
a seismic source station;
a seismic receiver station configured to sense seismic signals originating from a seismic source station;
a seismic data processor;
non-transitory computer-readable storage memory accessible by the seismic data processor and having executable code stored thereon for determining uphole velocities of an uphole velocity model from an uphole seismic survey dataset from the seismic signals, the executable code comprising a set of instructions that causes the seismic data processor to perform operations comprising:
obtaining the uphole seismic survey dataset comprising uphole travel times and respective depths;
removing anomalous uphole travel times from the uphole travel times to form a refined uphole travel times dataset;
forming a travel times vs depth function based on the refined uphole travel times dataset;
discretizing the uphole travels times vs. depth function to a plurality of depth intervals;
segmenting the plurality of depth intervals using a piecewise linear function;
identifying interval velocities at the corresponding segmented depth intervals; and
determining an uphole velocity model from the interval velocities at the corresponding segmented depth intervals.

23. The system of claim 22, the operations comprising generating a seismic image using the uphole velocity model.

24. The system of claim 22, wherein forming a travel times vs depth function based on the refined uphole travel times dataset comprises fitting the refined uphole travel times dataset by a cubic spline.
